(19) United States
(12) Patent Application Publication
(10) Pub. No.: US 2018/0246451 A1
(43) Pub. Date: Aug. 30, 2018

(54) IMAGE FORMING APPARATUS

(71) Applicant: CANON KABUSHIKI KAISHA, Tokyo (JP)

(72) Inventors: Shingo Ito, Tokyo (JP); Toshihiko Takayama, Kawasaki-shi (JP); Keisuke Ishizumi, Hiratsuka-shi (JP); Masaru Ohno, Ebina-shi (JP); Shohei Ishio, Tokyo (JP)

(21) Appl. No.: 15/898,152

(22) Filed: Feb. 15, 2018

(30) Foreign Application Priority Data
Feb. 27, 2017 (JP) 2017-035391

(51) Int. Cl. G03G 15/01

(52) U.S. Cl. CPC G03G 15/5004; G03G 2215/0103; G03G 15/0131; G03G 15/1605

(57) ABSTRACT

After primary transfer, in a state where a pressing force of a primary transfer brush is released to separate an intermediate transfer belt from a photosensitive drum, current is impeded to the primary transfer brush. After that, the total current supplied from a secondary transfer roller and a conductive brush is set as a total current whose value is smaller than that of the total current supplied during the primary transfer.

### BACKGROUND

### Field of the Disclosure

The present disclosure generally relates to an image forming apparatus of an electrophotographic system such as a copier or a printer.

### Description of the Related Art

It has been conventionally known that a color image forming apparatus of an electrophotographic system has a configuration in which toner images are sequentially transferred onto an intermediate transfer body from image forming portions of respective colors and the toner images are further transferred from the intermediate transfer body onto a transfer material together.

In such an image forming apparatus, each of the image forming portions of respective colors has a photosensitive member (hereinafter, referred to as a photosensitive drum) in a drum shape as an image carrying member. The toner images formed on photosensitive drums of the respective image forming portions are primary-transferred onto the intermediate transfer body by applying voltage from a primary transfer power supply to a primary transfer member which is opposed to the photosensitive drums across the intermediate transfer body such as an intermediate transfer belt. By applying voltage from a secondary transfer power supply to a secondary transfer member at a secondary transfer portion, the toner images of respective colors that are primary-transferred from the image forming portions of respective colors onto the intermediate transfer body are secondary-transferred from the intermediate transfer body onto a transfer material such as paper or an OHP sheet together. Each of the toner images of respective colors transferred onto the transfer material is then fixed by a fixing unit to the transfer material.

Japanese Patent Laid-Open No. 2013-231942 discloses a configuration in which primary transfer is performed by causing current to flow from a current supply unit that contacts an outer peripheral surface of an intermediate transfer belt to a photosensitive drum. More specifically, disclosed is a configuration in which a plurality of contact members that contact the outer peripheral surface of the intermediate transfer belt are provided as the current supply unit.

In the configuration in which the plurality of contact members are used as the current supply unit, however, a total current needs to be supplied from the plurality of contact members in consideration of a voltage drop, so that a total current with a relatively large value needs to be supplied. On the other hand, when current continuously flows through each of the contact members, electrical resistance tends to increase, and when the electrical resistance increases, a value of voltage applied to each of the contact members needs to be increased.

### SUMMARY OF THE DISCLOSURE

In an image forming apparatus in which a current supply unit includes a plurality of contact members that contact an outer peripheral surface of an intermediate transfer belt, an increase in electrical resistance of each of the contact members is suppressed.

The disclosure provides an image forming apparatus including: an image carrying member that carries a toner image; an intermediate transfer belt which has an endless shape and is movable and onto which the toner image from the image carrying member is primary-transferred; an abutting member that is pressed against the intermediate transfer belt from an inner peripheral surface of the intermediate transfer belt to cause the intermediate transfer belt to abut against the image carrying member; and a current supply unit that has a plurality of contact members contacting an outer peripheral surface of the intermediate transfer belt and supplies current to the intermediate transfer belt. The current supply unit supplies a first total current in a state where the abutting member is pressed against the intermediate transfer belt, and the toner image is primary-transferred from the image carrying member onto the intermediate transfer belt. After the toner image is primary-transferred from the image carrying member onto the intermediate transfer belt, in a state where a pressing force by which the abutting member is pressed against the intermediate transfer belt is released to separate the intermediate transfer belt from the image carrying member and where a second total current whose value is smaller than a value of the first total current is supplied from the current supply unit, the toner image that is primary-transferred onto the intermediate transfer belt is secondary-transferred onto a transfer material.

Further features of the present disclosure will become apparent from the following description of exemplary embodiments with reference to the attached drawings.

### BRIEF DESCRIPTION OF THE DRAWINGS

FIG. 1 is a schematic sectional view for explaining a configuration of an image forming apparatus of an exemplary embodiment 1.

FIG. 2 is a block diagram of a control system of the image forming apparatus of the exemplary embodiment 1.

FIGS. 3A and 3B are schematic views for explaining a configuration of an abutting member of the exemplary embodiment 1.

FIGS. 4A and 4B are schematic views for explaining potential formed in a facing member and the abutting member by a total current from a current supply unit in the exemplary embodiment 1.

FIG. 5 is a view for explaining a sequence of image formation in the exemplary embodiment 1.

FIG. 6 is a view of an evaluation result for explaining effects of exemplary embodiments 1 to 4.

FIGS. 7A and 7B are schematic views for explaining a configuration of an abutting member of a modified example of the exemplary embodiment 1.

FIG. 8 is a view for explaining a sequence of image formation in the exemplary embodiment 3.

FIG. 9A is a schematic sectional view for explaining a configuration of an image forming apparatus in the exemplary embodiment 4 and FIG. 9B is a block diagram of a control system thereof.

### DESCRIPTION OF THE EMBODIMENTS

Hereinafter, suitable exemplary embodiments of the disclosure will be described in detail with reference to the drawings. It would be appreciated that dimensions, materials, shapes, relative arrangement, and the like of components described in the following exemplary embodiments may be appropriately changed depending on a configuration of an apparatus to which the disclosure is applied and various conditions. They are not intended to limit the scope of the disclosure unless specified otherwise.

### Exemplary Embodiment 1

### [Configuration of Image Forming Apparatus]

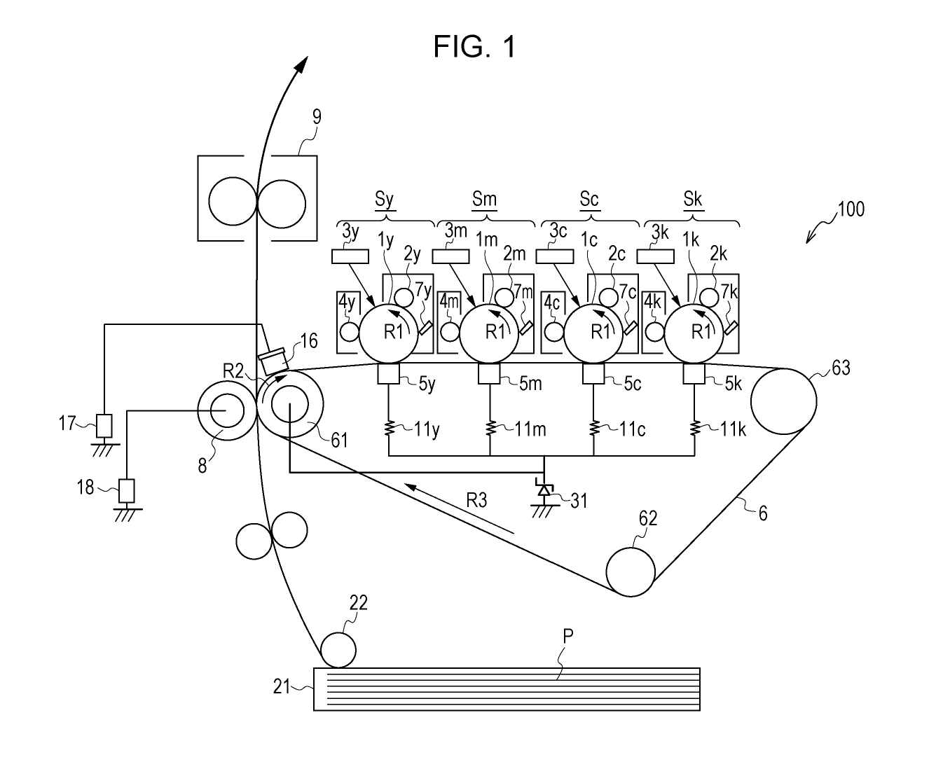

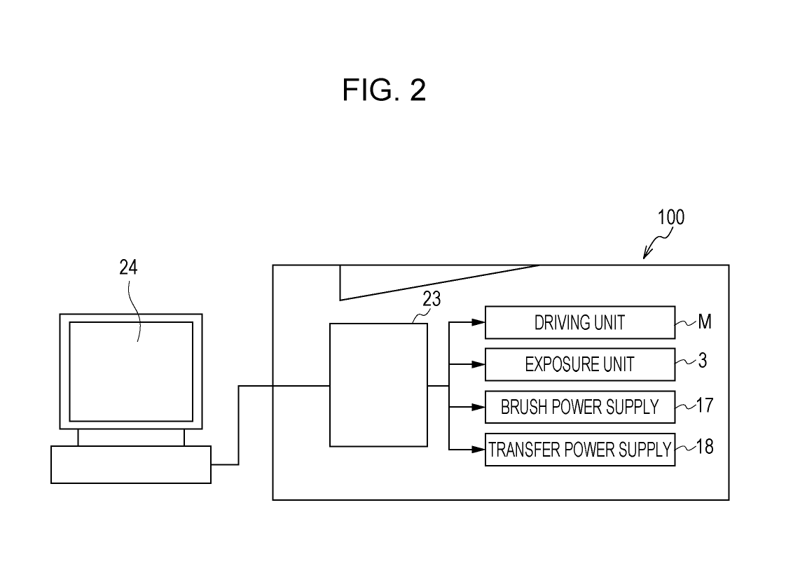

FIG. 1 is a schematic sectional view for explaining an image forming apparatus 100 of the present exemplary embodiment and FIG. 2 is a block diagram of a control system of the image forming apparatus 100 of the present exemplary embodiment. As illustrated in FIG. 2, the image forming apparatus 100 is connected to a personal computer 24 that is a host device. An operation start instruction and an image signal by the personal computer 24 are transmitted to a controller circuit 23 that is incorporated in the image forming apparatus 100 as a control unit. By controlling various units by the controller circuit 23, image formation is executed in the image forming apparatus 100.

As illustrated in FIG. 1, the image forming apparatus 100 of the present exemplary embodiment is a color image forming apparatus of a so-called tandem type that is provided with first, second, third, and fourth image forming portions Sy, Sm, Sc, and Sk as a plurality of image forming portions. The plurality of image forming portions S arranged in a movement direction of an intermediate transfer belt 6 form images with toner of respective colors of yellow (Y), magenta (M), cyan (C), and black (K). The four image forming portions S are disposed in a line with fixed gaps therebetween and substantially have many common configurations and operations except for the colors of the toner that is stored. Accordingly, in a case where particular distinction is not needed, description will be made by omitting suffixes y, m, c, and k given for representing the colors of constituent elements.

Each of the image forming portions S includes a photosensitive drum 1 that is an electrophotographic photoreceptor in a drum shape as an image carrying member. Further, at a periphery of the photosensitive drum 1, a charging roller 2 that is a charging unit, an exposure unit 3, a development unit 4, and a cleaning unit 7 are disposed. Primary transfer brushes 5 each serving as a primary transfer member are provided at positions opposing the photosensitive drums 1 across the intermediate transfer belt 6. Note that, the primary transfer brushes 5y, 5m, 5c, and 5k are respectively provided correspondingly to the photosensitive drums 1y, 1m, 1c, and 1k.

When the controller circuit 23 (illustrated in FIG. 2) receives an image signal, an image forming operation starts and each of the photosensitive drums 1 is rotationally driven at a predetermined circumferential velocity in a direction (counterclockwise direction) of an illustrated arrow R1 by a driving unit M (illustrated in FIG. 2). During the rotation, the photosensitive drum 1 is subjected to uniform charging processing by the charging roller 2 to a predetermined potential at a predetermined polarity (negative polarity in the present exemplary embodiment). After that, the photosensitive drum 1 is exposed by the exposure unit 3 in accordance with the image signal, so that an electrostatic latent image corresponding to a target image is formed on a surface of the photosensitive drum 1. The electrostatic latent image is developed by the development unit 4 at a development position and visualized as a toner image on the photosensitive drum 1.

In this case, a normal charging polarity of the toner stored in the development unit 4 is a negative polarity. In the present exemplary embodiment, the electrostatic latent image is inversely developed by the toner that is charged to the same polarity as the charging polarity of the photosensitive drum 1 by the charging roller 2. However, the disclosure is not limited thereto and is applicable also to an image forming apparatus in which an electrostatic latent image is normally developed by toner charged to a polarity opposite to the charging polarity of the photosensitive drum 1.

The intermediate transfer belt 6 having an endless shape and being movable has conductivity, is stretched around three rollers of a facing roller 61 as a facing member, an assist roller 62, and a tension roller 63, and contacts the photosensitive drums 1 to form a primary transfer portion. When the facing roller 61 is rotationally driven in a direction (clockwise direction) of an illustrated arrow R2, the intermediate transfer belt 6 rotationally moves at substantially the same circumferential velocity as that of the photosensitive drums 1 in a direction (clockwise direction) of an illustrated arrow R3. The primary transfer brushes 5 serving as an abutting member that causes the intermediate transfer belt 6 to abut against the photosensitive drums 1 by pressing the intermediate transfer belt 6 from an inner peripheral surface of the intermediate transfer belt 6 are disposed at positions at which the primary transfer brushes 5 oppose the photosensitive drums 1 with the intermediate transfer belt 6 interposed therebetween.

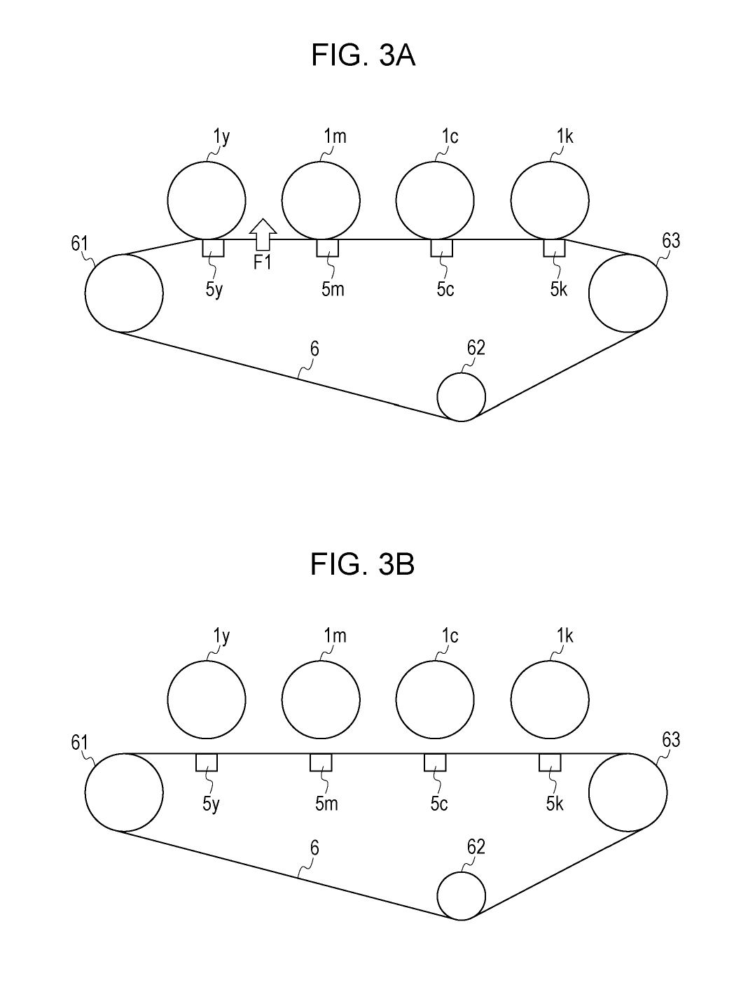

FIG. 3A is a schematic view for explaining a state where the primary transfer brushes 5 are pressed against the intermediate transfer belt 6 and FIG. 3B is a schematic view for explaining a state where a pressing force by which the primary transfer brushes 5 are pressed against the intermediate transfer belt 6 is released. As illustrated in FIG. 3A, an outer peripheral surface of the intermediate transfer belt 6 is able to abut against the photosensitive drums 1 by receiving a pressing force F1 from the primary transfer brushes 5 when the primary transfer brushes 5 are pressed by a pressing spring (not illustrated). Moreover, as illustrated in FIG. 3B, when the pressing force F1 from the primary transfer brushes 5 is released, the intermediate transfer belt 6 is separated from the photosensitive drums 1. Note that, in the present exemplary embodiment, the respective primary transfer brushes 5y, 5m, 5c, and 5k are able to be separately pressed against the intermediate transfer belt 6.

As each of the primary transfer brushes 5, one made from conductive fiber such as nylon or polyester in which carbon powder is dispersed may be used, and one in which electrical resistance of fiber is in a range of 10 to 10⁸ Ωcm is suitable from a viewpoint of transfer efficiency. In the present exemplary embodiment, conductive fiber which is obtained by dispersing carbon powder in nylon and in which electrical resistance of the fiber is about 10⁶ Ωcm is used as the primary transfer brush 5.

The toner image formed on the photosensitive drum 1 is primary-transferred from the photosensitive drum 1 onto the intermediate transfer belt 6 by current flowing from the primary transfer brush 5 to the photosensitive drum 1 through the intermediate transfer belt 6 in a process of passing through a primary transfer portion at which the photosensitive drum 1 contacts the intermediate transfer belt 6. Primary transfer residual toner remaining on a surface of the photosensitive drum 1 after the primary transfer is removed by the cleaning unit 7, and then, the photosensitive drum 1 is subjected to image forming processes following the charging again.

In the present exemplary embodiment, the toner image is primary-transferred from the photosensitive drum 1 onto the intermediate transfer belt 6 by current supplied from a secondary transfer roller 8 (first contact member) and a conductive brush 16 (second contact member) serving as contact members that contact the outer peripheral surface of the intermediate transfer belt 6. In this case, the secondary transfer roller 8 and the conductive brush 16 serve as a current supply unit that supplies current to the intermediate transfer belt 6. A configuration for the primary transfer in the present exemplary embodiment will be described later.

Processes from the charging up to the primary transfer described above are sequentially performed at each of the image forming portions S, so that toner images of four colors corresponding to a target color image are formed on the intermediate transfer belt 6. Then, the toner images of four colors carried by the intermediate transfer belt 6 are secondary-transferred together onto a surface of a transfer material P, such as paper or OHT, that is fed from a sheet feeding cassette 21 by a sheet feeding unit 22 in a process of passing through a secondary transfer portion formed by the secondary transfer roller 8 and the intermediate transfer belt 6 being in contact.

The secondary transfer roller 8 as the contact member that contacts the intermediate transfer belt 6 is connected to a transfer power supply 18, pressed against the facing roller 61 by force of 3 kgf with the intermediate transfer belt 6 interposed therebetween, and follows rotation of the intermediate transfer belt 6 to rotate. In the present exemplary embodiment, an NBR/hydrin-based elastic rubber roller whose volume resistivity is 10⁷ to 10⁹ Ωcm and rubber hardness is 30° (Asker C hardness) is used as the secondary transfer roller 8.

When voltage is applied from the transfer power supply 18 to the secondary transfer roller 8, current flows from the secondary transfer roller 8 to the facing roller 61 through the intermediate transfer belt 6 and the transfer material P, and the toner images of four colors carried by the intermediate transfer belt 6 are secondary-transferred onto the transfer material P. The toner images of four colors that are secondary-transferred onto the transfer material P are heated and pressurized by a fixing unit 9 and the toner images of four colors are melted and mixed to be fixed onto the transfer material P. Then, the transfer material P is discharged from the image forming apparatus 100 by a conveyance roller (not illustrated).

Toner (hereinafter, referred to as secondary transfer residual toner) that is not secondary-transferred onto the transfer material P and remains on the intermediate transfer belt 6 moves with the intermediate transfer belt 6 and is charged by the conductive brush 16. The conductive brush 16 is made from fiber in a brush shape having conductivity and being obtained by dispersing carbon in nylon, and is provided on a downstream side of the secondary transfer portion and on an upstream side of the photosensitive drums 1 in the movement direction of the intermediate transfer belt 6. In the conductive brush 16 of the present exemplary embodiment, a brush height that is a height of the fiber is 4.5 mm, electrical resistance of the fiber in the brush shape is 10¹⁰ to 10¹² ΩCm, and a brush density that is a density of fibers is 120 F/mm². The conductive brush 16 is fixed in a state of being pressed against a surface of the intermediate transfer belt 6 so that the brush height enters therein by about 1 mm.

The secondary transfer residual toner is charged to a positive polarity while passing through a position at which the conductive brush 16 to which voltage of a positive polarity is applied from a brush power supply 17 contacts the intermediate transfer belt 6. The secondary transfer residual toner that is charged to the positive polarity is electrostatically moved from the intermediate transfer belt 6 to each of the photosensitive drums 1 by a potential difference between the photosensitive drum 1 and the intermediate transfer belt 6 at the time of passing through the primary transfer portion, and is then cleaned by the cleaning unit 7.

### [Configuration for Primary Transfer]

As illustrated in FIG. 1, in the present exemplary embodiment, the facing roller 61 and each of the primary transfer brushes 5 that are conductive are electrically connected to each other through a resistance 11 and grounding is performed through a Zener diode 31 as a constant voltage element. The Zener diode 31 is an element that maintains a member connected to a cathode side at a predetermined potential (hereinafter, referred to as a Zener potential Vz) when current is supplied.

In the present exemplary embodiment, with a total current supplied from the secondary transfer roller 8 and the conductive brush 16 through the facing roller 61, the facing roller 61 and the primary transfer brush 5 that are connected to the cathode side of the Zener diode 31 are maintained at the Zener potential Vz. When current flows from the primary transfer brush 5 that is maintained at the Zener potential Vz to the photosensitive drum 1, the toner image carried by the photosensitive drum 1 is primary-transferred onto the intermediate transfer belt 6. That is, in the present exemplary embodiment, during the primary transfer, the primary transfer brush 5 needs to be maintained at the Zener potential Vz and current which allows the Zener diode 31 to cause Zener breakdown needs to be continuously caused to flow.

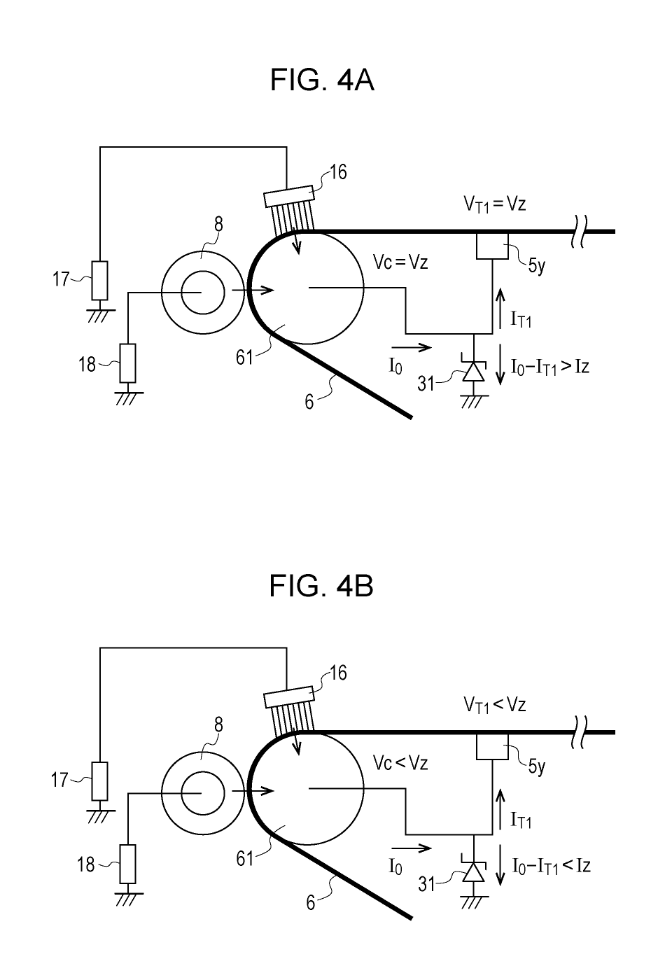

FIG. 4A is a schematic view for explaining a state where the facing roller 61 and the primary transfer brush 5 are maintained at the Zener potential Vz by a total current I₀ supplied from the secondary transfer roller 8 and the conductive brush 16. FIG. 4B is a schematic view for explaining a state where the facing roller 61 and the primary transfer brush 5 are not maintained at the Zener potential Vz by the total current I₀ supplied from the secondary transfer roller 8 and the conductive brush 16. The total current I₀ supplied from the secondary transfer roller 8 and the conductive brush 16 flows to the primary transfer brush 5 and the Zener diode 31 through the facing roller 61. Here, a current flowing through the primary transfer brush 5 is set as a current I_{T1} and a current which allows the Zener diode 31 to cause Zener breakdown is set as a current I_{z}.

As illustrated in FIG. 4A, in a case where the current flowing through the Zener diode 31 has a value greater than that of the current I_{z}, a potential Vc formed in the facing roller 61 and a potential V_{T1} formed in the primary transfer brush 5 become the Zener potential Vz. On the other hand, as illustrated in FIG. 4B, in a case where the current flowing through the Zener diode 31 has a value smaller than that of the current I_{z}, the Zener diode 31 is not allowed to cause Zener breakdown, so that the potential Vc and the potential V_{T1} become smaller than the Zener potential Vz.

In the state of FIG. 4B, when the potential V_{T1} becomes unstable, the current flowing to the photosensitive drum 1 becomes unstable and nonuniformity may be caused in primary transferability when the toner image is transferred from the photosensitive drum 1 onto the intermediate transfer belt 6. In addition, when the potential Vc becomes unstable, nonuniformity may be caused also in secondary transferability when the toner image is transferred from the intermediate transfer belt 6 onto the transfer material P.

Note that, the Zener diode 31 whose Zener potential Vz is 700 [V] is used in the present exemplary embodiment. In the configuration of the image forming apparatus 100 of the present exemplary embodiment, the potential Vz is set so that transfer efficiency when the toner image is primary-transferred from the photosensitive drum 1 onto the intermediate transfer belt 6 has a desired value. However, the Zener potential Vz is not limited thereto and may be appropriately set in accordance with the configuration of the image forming apparatus 100 or the transfer efficiency.

As described above, according to the configuration of the present exemplary embodiment, the primary transfer is able to be performed by the total current I₀ supplied from the secondary transfer roller 8 and the conductive brush 16 and the secondary transfer is able to be performed by the current supplied from the secondary transfer roller 8. Stable primary transferability and secondary transferability are able to be achieved by using the Zener diode 31.

However, in the configuration of the present exemplary embodiment in which the total current I₀ that is needed to perform the primary transfer is continuously supplied from the secondary transfer roller 8 and the conductive brush 16, the electrical resistance of the secondary transfer roller 8 and the conductive brush 16 tends to easily increase. When the electrical resistance of the secondary transfer roller 8 and the conductive brush 16 increases, a value of voltage output from the brush power supply 17 and the transfer power supply 18 needs to be increased in order to supply the total current I₀ by which the Zener potential Vz is able to be formed. That is, in order to supply the desired total current I₀, a high-voltage power supply that is able to ensure a sufficiently high output value needs to be used as the brush power supply 17 and the transfer power supply 18.

Then, in the present exemplary embodiment, an increase in the electrical resistance of the secondary transfer roller 8 and the conductive brush 16 is suppressed by the configuration described below.

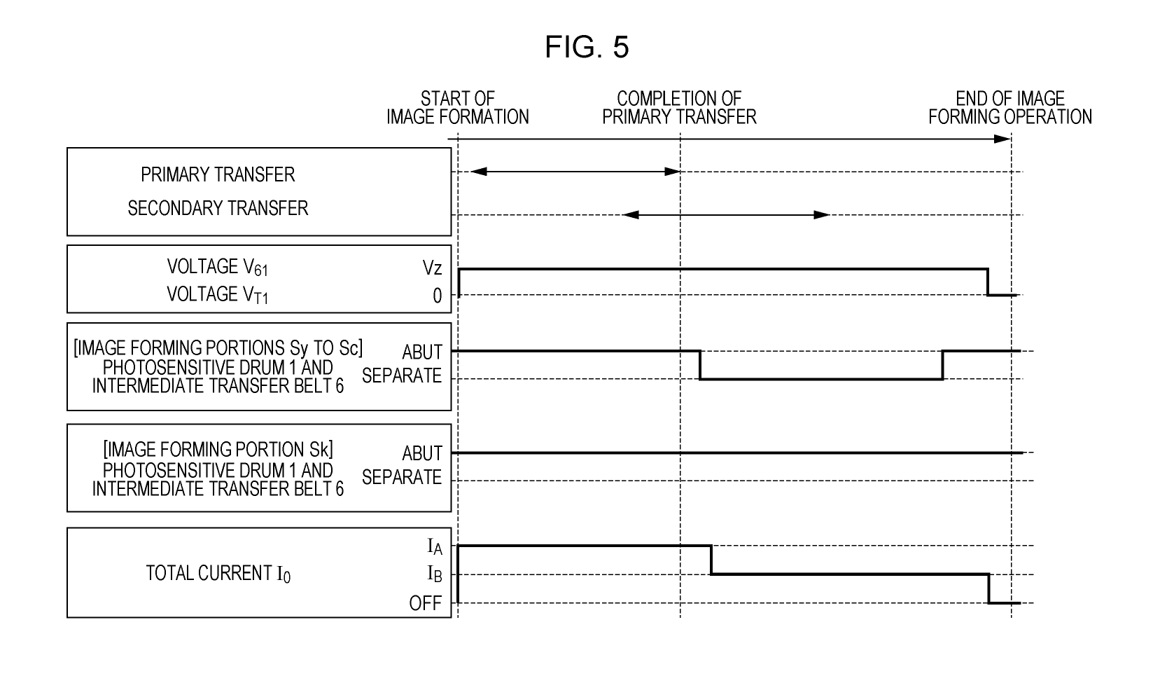

FIG. 5 is a view for explaining a sequence of an image forming operation in the present exemplary embodiment. In the present exemplary embodiment, description will be given with use of an example when an image is formed on two consecutive transfer materials P. Note that, when an image is formed on three or more consecutive transfer materials P, an operation after the primary transfer is completed is basically the same except that times of the primary transfer and the secondary transfer illustrated in FIG. 5 are extended. While the image formation is performed, the controller circuit 23 controls the brush power supply 17 and the transfer power supply 18, so that a predetermined current is supplied from the secondary transfer roller 8 and the conductive brush 16.

As illustrated in FIG. 5, until the primary transfer is completed after the image formation starts, in the four image forming portions S, the primary transfer brushes 5 are pressed against the intermediate transfer belt 6 so that the photosensitive drums 1 abut against the intermediate transfer belt 6. At this time, a total current I_{A} (first total current) that is needed to perform the primary transfer is supplied from the secondary transfer roller 8 and the conductive brush 16. The total current I_{A} in the present exemplary embodiment is 50 μA. Note that, a ratio of the current supplied from the secondary transfer roller 8 and the current supplied from the conductive brush 16 may be changed as appropriate in accordance with the configuration or the like of the image forming apparatus 100 as long as the total current I_{A} is 50 μA.

With the total current I_{A}, current equal to or more than the current I_{z} that is needed to cause Zener breakdown is supplied to the Zener diode 31 and the Zener potential Vz is formed in the facing roller 61 and the primary transfer brushes 5. The current I_{z} in the present exemplary embodiment is about 10 μA, and when current of a value greater than 10 μA flows through the Zener diode 31, Zener breakdown is caused. Note that, the current I_{z} is set by considering a case where voltage or current suddenly changes, for example, at timing when the transfer material P enters the secondary transfer portion, when a printing ratio of an image suddenly changes, or when a value of the total current I₀ is switched. In consideration of these things, in the configuration of the present exemplary embodiment, the current I_{z} needs to be about 10 μA in order for the Zener diode 31 to cause Zener breakdown.

When the primary transfer is completed for the second transfer material P, the primary transfer brushes 5s, 5y, and 5m in the image forming portions Sy, Sm, and Sc release the pressing force F1 by which the intermediate transfer belt 6 is pressed. Thereby, the intermediate transfer belt 6 is separated from the photosensitive drums 1y, 1m, and 1c. Then, the total current I₀ supplied from the secondary transfer roller 8 and the conductive brush 16 is set to a total current I_{B} (second total current). In the present exemplary embodiment, the total current I_{B} is 35 μA, and the total current I₀ is reduced from 50 μA to 35 μA after toner images are primary-transferred from the photosensitive drums 1 onto the intermediate transfer belt 6. At this time, the toner images are secondary-transferred onto the first transfer material P at the secondary transfer portion.

In the configuration of the present exemplary embodiment, the current supplied from the secondary transfer roller 8 to the facing roller 61 in order for the toner images to be secondary-transferred from the intermediate transfer belt 6 onto the transfer material P is about 15 μA and the value is not able to be changed while the secondary transfer is being performed. Thus, after the primary transfer is completed, the total current I_{B} is supplied in such a manner that the current of 15 μA is supplied from the secondary transfer roller 8 and the current of 20 μA is supplied from the conductive brush 16. At this time, as a result of monitoring a potential V₆₁ of the facing roller 61 and the potential V_{T1} of each of the primary transfer brushes 5 by an electrometer, both the potentials are stable at the Zener potential Vz (700 [V]).

As described above, in the present exemplary embodiment, even when the total current I₀ is reduced from 50 μA to 35 μA, the potential V₆₁ formed in the facing roller 61 and the potential V_{T1} formed in the primary transfer brush 5 are able to be maintained at the Zener potential Vz. This is because when the pressing force F1 of the primary transfer brushes 5y, 5m, and 5c is released, the current I_{T1} flowing to each of the primary transfer brushes 5 becomes difficult to flow. As a result, even when the total current I₀ is reduced to a certain degree, current equal to or more than the current I_{z} is able to be supplied to the Zener diode 31 and the facing roller 61 and the primary transfer brushes 5 are able to be maintained at the Zener potential Vz. Note that, though the pressing force F1 of the primary transfer brushes 5y, 5m, and 5c is released in the three image forming portions S in the present exemplary embodiment, without limitation thereto, the value of the total current I₀ is able to be reduced by releasing the pressing force F1 of at least one of the first primary brushes 5.

Until when the secondary transfer is completed and collection of the secondary transfer residual toner remaining on the intermediate transfer belt 6 is finished, the pressing force F1 is released to maintain a state where the total current I_{B} is supplied from the secondary transfer roller 8 and the conductive brush 16. First, the secondary transfer residual toner remaining on the intermediate transfer belt 6 is charged to the positive polarity at the time of passing through a position at which the conductive brush 16 contacts the intermediate transfer belt 6. Then, at a position where the photosensitive drum 1k abuts against the intermediate transfer belt 6 due to pressing by the primary transfer brush 5k, the secondary transfer residual toner is electrostatically moved to the photosensitive drum 1k and then collected by the cleaning unit 7k that abuts against the photosensitive drum 1k.

Note that, in the present exemplary embodiment, in order to collect the secondary transfer residual toner, a state where the pressing force F1 of at least one of the primary transfer brushes 5 in the image forming portions S is not released and at least one of the photosensitive drums 1 abuts against the intermediate transfer belt 6 is provided. However, in a state where the pressing force F1 of all the primary transfer brushes 5 is not released, the value of the total current I₀ described above is not able to be reduced, so that the pressing force F1 of at least any one of the four primary transfer brushes 5 needs to be released to achieve an effect of the present exemplary embodiment.

When the collection of the secondary transfer residual toner is completed, all the primary transfer brushes 5 are pressed again against the intermediate transfer belt 6 to cause the intermediate transfer belt 6 to abut against the photosensitive drums 1 and the current flowing through each member is set to zero, and then, rotation of the photosensitive drums 1 and the intermediate transfer belt 6 stops.

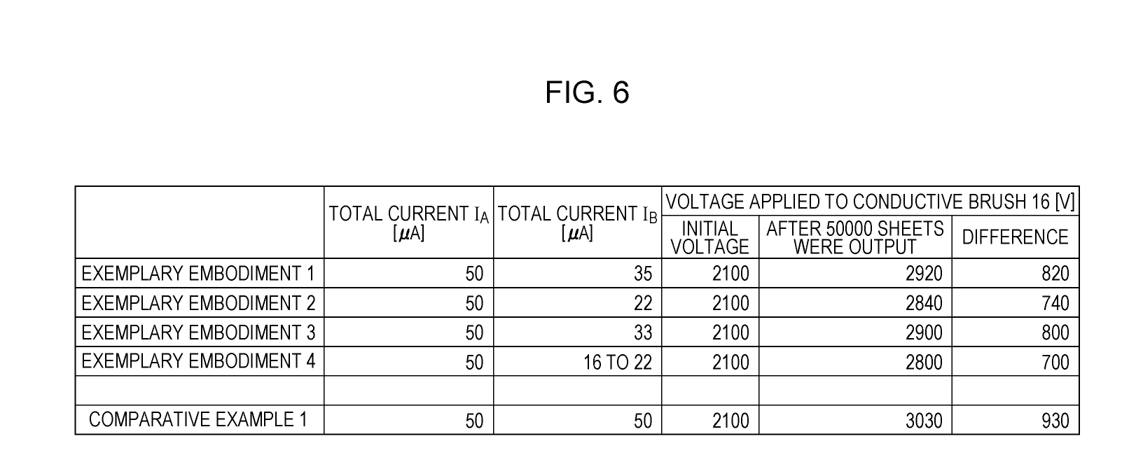

Next, an evaluation method for verifying the effect of the present exemplary embodiment with use of a comparative example 1 and an evaluation result will be described with reference to FIG. 6. FIG. 6 illustrates the evaluation result in each of exemplary embodiments and the comparative example. As the evaluation method, an increased amount of resistance of the conductive brush 16 after an image with a printing ratio of 1% was output on 50000 sheets with a 2 sheet-interval in the image forming apparatus 100 was calculated. An evaluation environment was as follows: temperature was 23° C. and humidity was 50%.

The increased amount of the resistance of the conductive brush 16 was calculated in such a manner that voltages applied from the brush power supply 17 to the conductive brush 16 when the intermediate transfer belt 6 rotated and the current of 50 μA flowed through the conductive brush 16 were compared between before and after the 50000 sheets were output. That is, as a difference between the voltages applied from the brush power supply 17 between before and after the 50000 sheets of the transfer materials P are output becomes great, the electrical resistance of the conductive brush 16 increases.

Here, the comparative example 1 has a configuration in which the pressing force F1 of the primary transfer brushes 5 is not released and the total current I₀ supplied from the secondary transfer roller 8 and the conductive brush 16 is not changed during the primary transfer and the secondary transfer.

As illustrated in FIG. 6, in both the present exemplary embodiment and the comparative example, the initial voltage applied from the brush power supply 17 to the conductive brush 16 to supply the current of 50 μA to the conductive brush 16 before the image formation on the 50000 sheets of the transfer materials P started was 2100 [V]. On the other hand, the voltage applied from the brush power supply 17 to the conductive brush 16 to supply the current of 50 μA to the conductive brush 16 after the 50000 sheets were output was 2920 [V] in the present exemplary embodiment and 3030 [V] in the comparative example 1. That is, while the difference from the initial voltage was 820 [V] in the present exemplary embodiment, the difference from the initial voltage was 930 [V] in the comparative example 1, so that it was revealed that the electrical resistance of the conductive brush 16 was increased in the configuration of the comparative example 1 more than the configuration of the present exemplary embodiment.

As described above, according to the configuration of the present exemplary embodiment, in the image forming apparatus 100 in which the primary transfer is performed by the total current I₀ supplied from the secondary transfer roller 8 and the conductive brush 16, the value of the total current I₀ is able to be reduced from the total current I_{A} to the total current I_{B} after the primary transfer. This makes it possible to suppress an increase in the electrical resistance of the secondary transfer roller 8 and the conductive brush 16.

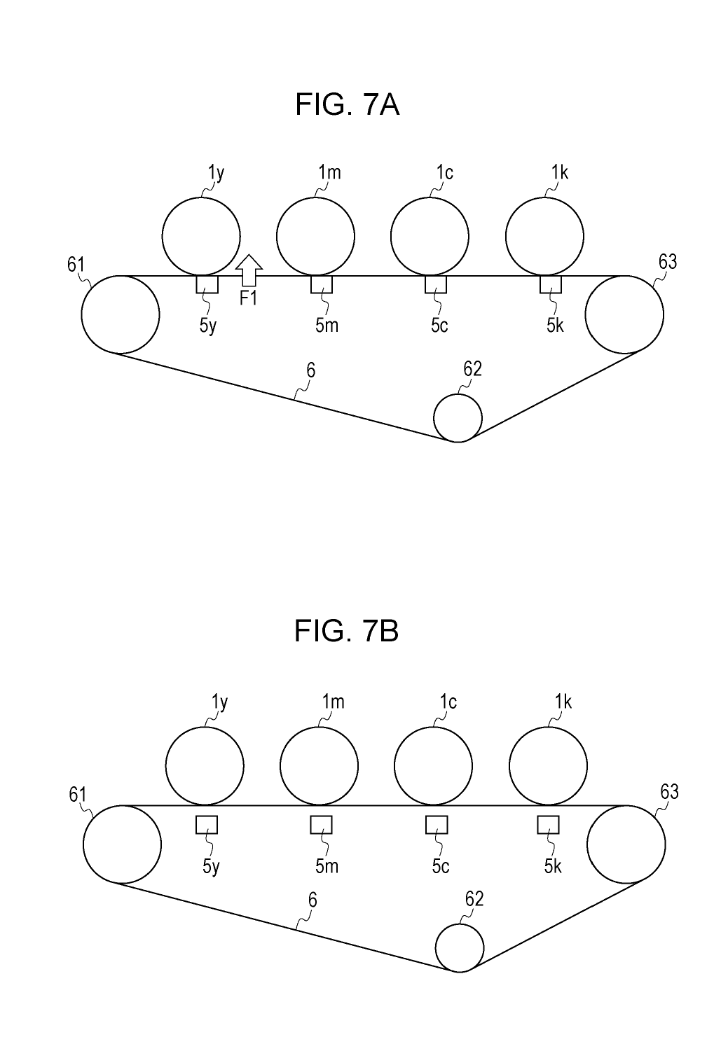

In the present exemplary embodiment, it is configured such that by releasing the pressing force F1 of the primary transfer brushes 5, the intermediate transfer belt 6 is separated from the photosensitive drums 1, so that the current I_{T1} is difficult to flow. However, without limitation thereto, a similar effect to that of the present exemplary embodiment is able to be achieved also by a configuration in which the primary transfer brushes 5 are separated from the intermediate transfer belt 6 when the pressing force F1 of the primary transfer brushes 5 is released, so that the current I_{T1} is difficult to flow, as illustrated in FIGS. 7A and 7B.

### Exemplary Embodiment 2

In the exemplary embodiment 1, a configuration in which the total current I_{B} of 35 μA is supplied from the secondary transfer roller 8 and the conductive brush 16 after the toner images are primary-transferred from the photosensitive drums 1 onto the intermediate transfer belt 6 and after the pressing force F1 of the primary transfer brushes 5 is released has been described. On the other hand, in an exemplary embodiment 2, a configuration in which the total current I_{B} of 22 μA is supplied from the secondary transfer roller 8 and the conductive brush 16 as illustrated in FIG. 6 will be described. Note that, since the configuration of the present exemplary embodiment is similar to that of the exemplary embodiment 1 except that the total current I_{B} of 22 μA is supplied from the secondary transfer roller 8 and the conductive brush 16 after the primary transfer, the same portion is given the same reference sign and description thereof is omitted.

In the present exemplary embodiment, the total current I_{A} during the primary transfer was set to 50 μA and the current of 15 μA was supplied from the secondary transfer roller 8 and the current of 7 μA was supplied from the conductive brush 16 after the primary transfer and after the pressing force F1 of the primary transfer brushes 5y, 5m, and 5c was released. Thereby, as illustrated in FIG. 6, compared to the initial voltage applied to the conductive brush 16 before the 50000 sheets were output, the voltage applied to the conductive brush 16 after the 50000 sheets were output was 2840 [V] and a difference from the initial voltage was 740 [V]. In this manner, as the value of the total current I_{B} is smaller, an increase in the electrical resistance of the conductive brush 16 is able to be further suppressed.

Note that, the value of the total current I_{B} supplied from the secondary transfer roller 8 and the conductive brush 16 after the pressing force F1 of the primary transfer brushes 5 is released can satisfy the following (formula 1).

$${I}_{A} > {I}_{B} \geq ( {I}_{A} - {I}_{Z} ) \frac{{N}_{B}}{{N}_{A}} + {I}_{Z} \qquad ( 1 )$$

In the formula, I_{A} is a value of the total current I₀ before the pressing force F1 of the primary transfer brushes 5 is released and I_{B} is a value of the total current I₀ after the pressing force F1 of the primary transfer brushes 5 is released. Moreover, N_{A} is the number of the photosensitive drums 1 abutting against the intermediate transfer belt 6 before the pressing force F1 of the primary transfer brushes 5 is released and N_{B} is the number of the photosensitive drums 1 abutting against the intermediate transfer belt 6 after the pressing force F1 of the primary transfer brushes 5 is released. In the present exemplary embodiment, N_{A} is 4, N_{B} is 1, I_{A} is 50 μA, and I_{z} is 10 μA. Thus, (50−10)/4+10=20 in the right side of the formula 1, and the total current I_{B} needs to be 20 μA or more at minimum for stabilizing the secondary transfer after the primary transfer.

As described above, the present exemplary embodiment is also able to achieve an effect similar to that of the exemplary embodiment 1. Not that, an effect of suppressing an increase in the electrical resistance is achieved as the value of the total current I_{B} is smaller, but the total current I_{B} needs to be set in a range of satisfying the formula 1 by considering that the potential to perform stable secondary transfer is formed in the facing roller 61.

### Exemplary Embodiment 3

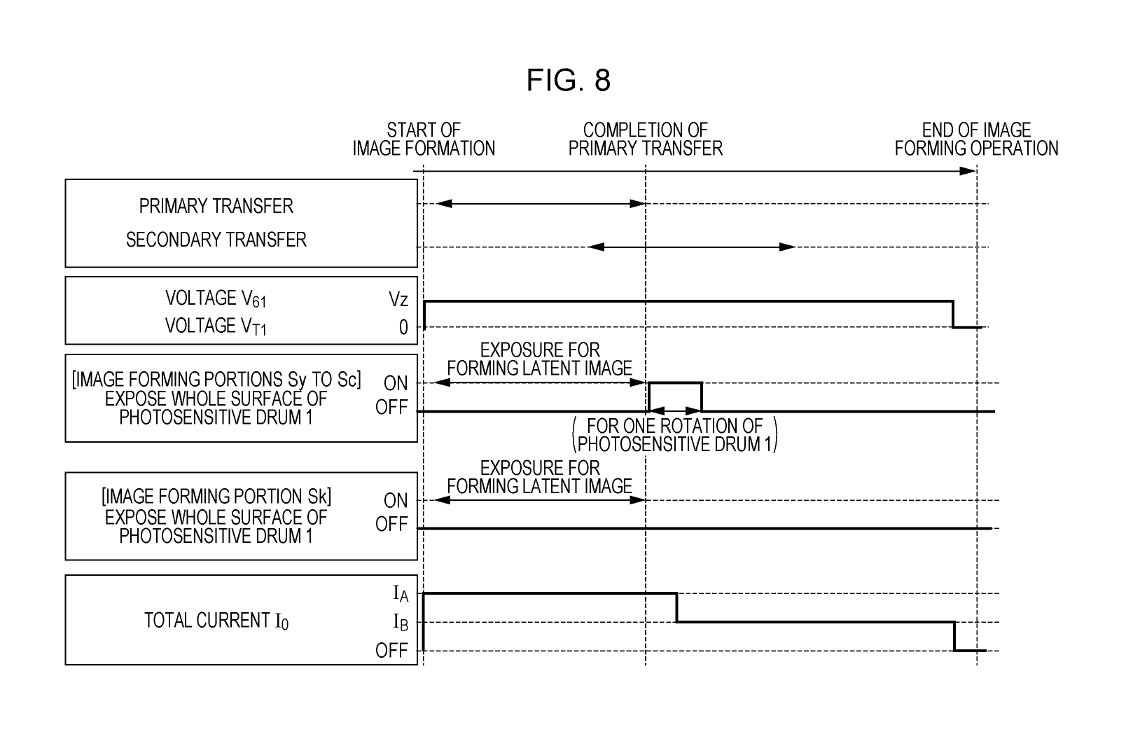

In the exemplary embodiment 1, a configuration in which the pressing force F1 of the primary transfer brushes 5 as the abutting member is released, so that the current I_{T1} is difficult to flow has been described. On the other hand, in an exemplary embodiment 3, as illustrated in FIG. 8, a configuration in which whole surfaces of the photosensitive drums 1 are exposed instead of releasing the pressing force F1 of the primary transfer brushes 5 and the potential difference between each of the photosensitive drums 1 and the intermediate transfer belt 6 is reduced, so that the current I_{T1} is difficult to flow will be described. Note that, since the configuration of the present exemplary embodiment is similar to that of the exemplary embodiment 1 except that whole surfaces of the photosensitive drums 1 are exposed instead of releasing the pressing force F1 of the primary transfer brushes 5, the same portion is given the same reference sign and description thereof is omitted.

FIG. 8 is a view for explaining a sequence of an image forming operation in the present exemplary embodiment. In the present exemplary embodiment as well, description will be given with use of an example when an image is formed on two consecutive transfer materials P similarly to the exemplary embodiment 1. As illustrated in FIG. 8, until the image formation started and the primary transfer was completed, a latent image potential corresponding to image information was formed on the photosensitive drums 1 by exposure from the exposure units 3. Then, after the primary transfer was completed for the second transfer material P, the whole surfaces of the photosensitive drums 1y, 1m, and 1c in the image forming portions Sy, Sm, and Sc were exposed by the exposure units 3 for one rotation of the photosensitive drum 1k. As a result, the potential of −100 [V] was formed on the surfaces of the photosensitive drums 1y, 1m, and 1c and a potential difference from the potential (700 [V]) formed in the primary transfer brushes 5y, 5m, and 5c was 800 [V].

Note that, in a case where the whole surfaces are not exposed by the exposure units 3, the surfaces of the photosensitive drums 1 are charged by the charging rollers 2, so that the potential of −500 [V] is formed thereon. That is, in the present exemplary embodiment, the whole surfaces of the photosensitive drums 1y, 1m, and 1c were exposed by the exposure units 3, so that the potential difference formed between the potential of the photosensitive drums 1 and the potential of the primary transfer brushes 5 was reduced from 1200 [V] to 800 [V].

Note that, the latent image potential formed in the photosensitive drums 1 during the primary transfer is set on the basis of the configuration of the image forming apparatus 100 and is set to be from −150 to −300 [V] in the present exemplary embodiment. In order to expose the whole surfaces of the photosensitive drums 1 by the exposure units 3 and make it difficult to cause the current to flow through the primary transfer brushes 5 after the primary transfer, the potential difference between the photosensitive drums 1 whole surfaces of which have been exposed and the intermediate transfer belt 6 can be equal to or less than the potential difference during the primary transfer.

The value of the current flowing from the primary transfer brushes 5 to the photosensitive drums 1 when the whole surfaces are not exposed is 37 μA, and the value of the current flowing from the primary transfer brushes 5y, 5m, and 5c to the photosensitive drums 1y, 1m, and 1c when the whole surfaces are exposed is 20 μA. Thus, with the configuration of the present exemplary embodiment, the current is difficult to flow from the primary transfer brushes 5y, 5m, and 5c to the photosensitive drums 1y, 1m, and 1c, so that the value of the total current I₀ is able to be reduced accordingly.

In the present exemplary embodiment, the total current I₀ supplied from the secondary transfer roller 8 and the conductive brush 16 after the primary transfer and after the whole surfaces of the photosensitive drums 1y, 1m, and 1c were exposed was changed from the total current I_{A} (first total current) during the primary transfer to the total current I_{B} (second total current). At this time, the toner images are secondary-transferred onto the first transfer material P at the secondary transfer portion. Note that, the total current I_{A} and the total current I_{B} supplied from the secondary transfer roller 8 and the conductive brush 16 when performing the primary transfer, that is, before exposing the whole surfaces of the photosensitive drums 1y, 1m, and 1c were respectively set to 50 μA and 33 μA.

In the present exemplary embodiment as well, the whole surfaces of the photosensitive drums 1y, 1m, and 1c in the three image forming portions S are exposed similarly to the exemplary embodiment 1, but without limitation thereto, the value of the total current I₀ is able to be reduced by exposing the whole surface of at least one of the photosensitive drums 1. Also in the present exemplary embodiment, in order to collect the secondary transfer residual toner remaining on the intermediate transfer belt 6, the whole surface of the photosensitive drum 1k was not exposed and the secondary transfer residual toner was electrostatically moved to the photosensitive drum 1k at a position where the photosensitive drum 1k was in contact with the intermediate transfer belt 6.

In order to collect the secondary transfer residual toner, the whole surface of at least one of the photosensitive drums 1 is not exposed, but when the whole surfaces of all the photosensitive drums 1 are not exposed, the value of the total current I₀ described above is not able to be reduced. Thus, the whole surface of at least one of the four photosensitive drums 1 needs to be exposed in order to achieve an effect of the present exemplary embodiment.

As illustrated in FIG. 6, with respect to the initial voltage applied to the conductive brush 16 before the 50000 sheets were output, the voltage applied to the conductive brush 16 after the 50000 sheets were output was 2900 [V] and a difference from the initial voltage was 800 [V]. In this manner, an effect similar to that of the exemplary embodiment 1 is able to be achieved also in the configuration of the present exemplary embodiment.

### Exemplary Embodiment 4

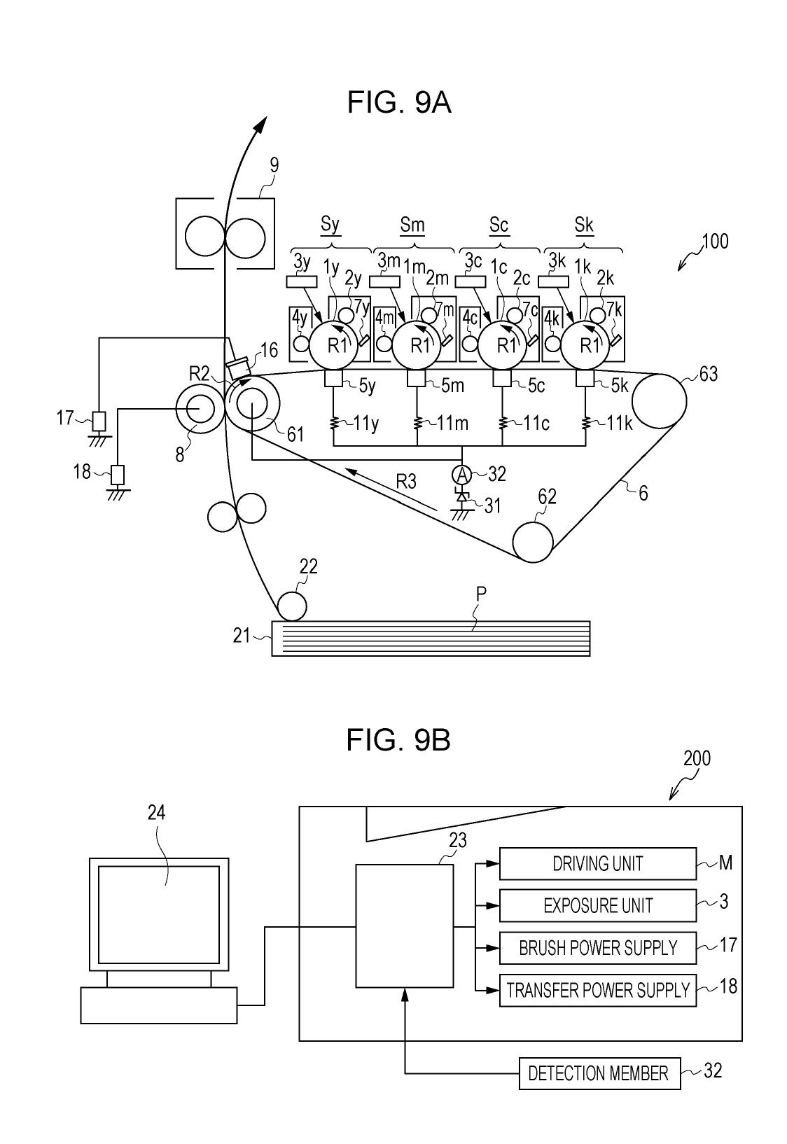

In the exemplary embodiment 1, a configuration in which the total current I_{B} that is set in advance is supplied from the secondary transfer roller 8 and the conductive brush 16 after the primary transfer and after the pressing force F1 of the primary transfer brushes 5 is released has been described. On the other hand, as illustrated in FIGS. 9A and 9B, an exemplary embodiment 4 is different from the exemplary embodiment 1 in that a detection member 32 that detects a value of the current flowing through the Zener diode 31 is provided and the total current I_{B} is supplied in accordance with the value of the current detected by the detection member 32. Note that, a configuration of an image forming apparatus 200 of the present exemplary embodiment is similar to that of the exemplary embodiment 1 except that the detection member 32 is provided and the total current I_{B} is supplied in accordance with the value of the current detected by the detection member 32, so that the same portion as the exemplary embodiment 1 is given the same reference sign and description thereof is omitted.

FIG. 9A is a schematic sectional view for explaining the configuration of the image forming apparatus 200 of the present exemplary embodiment and FIG. 9B is a block diagram for explaining a control system of the image forming apparatus 200 of the present exemplary embodiment. As illustrated in FIGS. 9A and 9B, the detection member 32 is able to detect the current flowing through the Zener diode 31 and feed back a result of the detection to the controller circuit 32. The controller circuit 23 is a control unit that is able to control the value of the total current I₀ supplied from the secondary transfer roller 8 and the conductive brush 16 in accordance with the value detected by the detection member 32.

As described above, the total current I_{B} is able to be set in accordance with the current flowing through the Zener diode 31 in the present exemplary embodiment. Thereby, when the current flowing from the primary transfer brushes 5 to the photosensitive drums 1 changes, for example, because of a variation in the electrical resistance of the intermediate transfer belt 6 or a change in a film thickness of the photosensitive drums 1 due to abrasion or replacement, appropriate current is able to be supplied to the Zener diode 31. As a result, the total current I_{A} and the total current I_{B} supplied from the secondary transfer roller 8 and the conductive brush 16 during the primary transfer and after the primary transfer is completed are able to be suppressed to a necessary minimum.

As illustrated in FIG. 6, the total current I_{B} after the primary transfer was controlled in accordance with the detection result of the detection member 32 and varied between 16 to 22 μA, but the potential formed in the facing roller 61 and the primary transfer brushes 5 was always stable at the Zener potential Vz. With respect to the initial voltage applied to the conductive brush 16 before the 50000 sheets were output, the voltage applied to the conductive brush 16 after the 50000 sheets were output was 2800 [V] and a difference from the initial voltage was 700 [V] in the present exemplary embodiment. In this manner, by supplying the appropriate total current I_{B} from the secondary transfer roller 8 and the conductive brush 16 after the primary transfer, an effect similar to that of the exemplary embodiment 1 is able to be achieved in the configuration of the present exemplary embodiment.

Note that, the configuration of providing the detection member 32 that detects the current and the control as in the present exemplary embodiment are able to be used not only for the configurations of the exemplary embodiments 1 and 2 but also for the configuration of the exemplary embodiment 3 and achieve a similar effect.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-035391 filed Feb. 27, 2017, which is hereby incorporated by reference herein in its entirety.

What is claimed is:

1. An image forming apparatus comprising:
an image carrying member that carries a toner image;
an intermediate transfer belt which has an endless shape and is movable and onto which the toner image from the image carrying member is primary-transferred;
an abutting member that is pressed against the intermediate transfer belt from an inner peripheral surface of the intermediate transfer belt to cause the intermediate transfer belt to abut against the image carrying member; and
a current supply unit that has a plurality of contact members contacting an outer peripheral surface of the intermediate transfer belt and supplies current to the intermediate transfer belt, the current supply unit supplying a first total current in a state where the abutting member is pressed against the intermediate transfer belt, so that the toner image is primary-transferred from the image carrying member onto the intermediate transfer belt, wherein
after the toner image is primary-transferred from the image carrying member onto the intermediate transfer belt, in a state where a pressing force by which the abutting member is pressed against the intermediate transfer belt is released to separate the intermediate transfer belt from the image carrying member and where a second total current whose value is smaller than a value of the first total current is supplied from the current supply unit, the toner image that is primary-transferred onto the intermediate transfer belt is secondary-transferred onto a transfer material.

2. The image forming apparatus according to claim 1, further comprising:
a facing member that faces the current supply unit with the intermediate transfer belt interposed therebetween; and
a constant voltage element that is electrically connected to the facing member and the abutting member and maintains the facing member and the abutting member at a predetermined voltage by the first total current and the second total current being supplied through the facing member.

3. The image forming apparatus according to claim 2, wherein
a plurality of image carrying members are disposed in a movement direction of the intermediate transfer belt, a plurality of abutting members are disposed at positions corresponding to positions of the plurality of image carrying members with the intermediate transfer belt interposed therebetween, and, after the toner image is primary-transferred from each of the plurality of image carrying members onto the intermediate transfer belt by current flowing from the plurality of abutting members to the plurality of image carrying members, the pressing force of at least one of the plurality of abutting members is released.

4. The image forming apparatus according to claim 3, wherein
in a case where the pressing force of at least one of the plurality of abutting members is released, the toner image is secondary-transferred from the intermediate transfer belt onto the transfer material in a state where the pressing force of at least one of the abutting members is not released.

5. The image forming apparatus according to claim 4, wherein
the current supply unit includes a first contact member that supplies current by which the toner image is secondary-transferred from the intermediate transfer belt onto the transfer material, and a second contact member that is provided on a downstream side of the first contact member in the movement direction of the intermediate transfer belt and subjected to application of voltage from a power supply, and
toner remaining on the intermediate transfer belt after the toner image is secondary-transferred from the intermediate transfer belt onto the transfer material moves with the intermediate transfer belt, is charged while passing through a position where the second contact member, to which voltage of a polarity opposite to a normal charging polarity of toner is applied from the power supply, abuts against the intermediate transfer belt, and then moves from the intermediate transfer belt to the image carrying member at a position where the image carrying member abuts against the intermediate transfer belt.

6. The image forming apparatus according to claim 5, wherein
until the toner remaining on the intermediate transfer belt after the toner image is secondary-transferred from the intermediate transfer belt onto the transfer material finishes moving to the image carrying member, the abutting member the pressing force of which has been released is maintained in a state where the pressing force is released.

7. The image forming apparatus according to claim 3, wherein
I_{A} that is the value of the second total current satisfies:
$${I}_{A} > {I}_{B} \geq ( {I}_{A} - {I}_{Z} ) \frac{{N}_{B}}{{N}_{A}} + {I}_{Z}$$
where a current needed for the constant voltage element to maintain the predetermined voltage is I_{z}, the number of the abutting members pressed against the intermediate transfer belt while the toner image is primary-transferred from the image carrying member onto the intermediate transfer belt is N_{B}, the value of the first total current is I_{B}, and the number of the abutting members the pressing force of which is released after the toner image is primary-transferred from the image carrying member onto the intermediate transfer belt is N_{A}.

8. The image forming apparatus according to claim 3, further comprising:
a detection member that is able to detect current flowing through the constant voltage element; and
a control unit that controls current supplied from the current supply unit in accordance with a value detected by the detection member after the toner image is primary-transferred from the image carrying member onto the intermediate transfer belt.

9. An image forming apparatus comprising:
an image carrying member that carries a toner image;
an exposure unit that exposes the image carrying member;
an intermediate transfer belt which has conductivity and an endless shape, and is movable, and onto which the toner image from the image carrying member is primary-transferred;
an abutting member that abuts against an inner peripheral surface of the intermediate transfer belt; and
a current supply unit that has a plurality of contact members contacting an outer peripheral surface of the intermediate transfer belt and supplies current to the intermediate transfer belt, the current supply unit supplying a first total current, so that the toner image is primary-transferred from the image carrying member onto the intermediate transfer belt, wherein
after the toner image is primary-transferred from the image carrying member onto the intermediate transfer belt, in a state where a surface of the image carrying member is uniformly exposed by the exposure unit, so that a potential difference between the image carrying member and the intermediate transfer belt is set to be equal to or less than a potential difference obtained when the toner image is primary-transferred onto the intermediate transfer belt and where a second total current whose value is smaller than a value of the first total current is supplied from the current supply unit, the toner image that is primary-transferred onto the intermediate transfer belt is secondary-transferred onto a transfer material.

10. The image forming apparatus according to claim 9, further comprising:
a facing member that faces the current supply unit with the intermediate transfer belt interposed therebetween; and
a constant voltage element that is electrically connected to the facing member and the abutting member and maintains the facing member and the abutting member at a predetermined voltage by the first total current and the second total current being supplied through the facing member.

11. The image forming apparatus according to claim 10, wherein
a plurality of image carrying members are disposed in a movement direction of the intermediate transfer belt, and, after the toner image is primary-transferred from each of the plurality of image carrying members onto the intermediate transfer belt, a surface of at least one of the plurality of image carrying members is uniformly exposed by the exposure unit so that a potential difference between the image carrying member and the intermediate transfer belt is equal to or less than a potential difference obtained when the toner image is primary-transferred onto the intermediate transfer belt.

12. The image forming apparatus according to claim 11, wherein
in a case where the surface of at least one of the plurality of image carrying members is uniformly exposed by the exposure unit, the toner image is secondary-transferred from the intermediate transfer belt onto the transfer material without uniformly exposing a surface of at least one of the image carrying members.

13. The image forming apparatus according to claim 12, wherein
the current supply unit includes a first contact member that supplies current by which the toner image is secondary-transferred from the intermediate transfer belt onto the transfer material, and a second contact member that is provided on a downstream side of the first contact member in the movement direction of the intermediate transfer belt and subjected to application of voltage from a power supply, and
toner remaining on the intermediate transfer belt after the toner image is secondary-transferred from the intermediate transfer belt onto the transfer material moves with the intermediate transfer belt, is charged while passing through a position where the second contact member, to which voltage of a polarity opposite to a normal charging polarity of toner is applied from the power supply, abuts against the intermediate transfer belt, and then moves from the intermediate transfer belt to the image carrying member at a position where the image carrying member abuts against the intermediate transfer belt.

14. An image forming apparatus comprising:
an image carrying member that carries a toner image;
an intermediate transfer belt which has an endless shape and is movable and onto which the toner image from the image carrying member is primary-transferred;
an abutting member that is pressed against the intermediate transfer belt from an inner peripheral surface of the intermediate transfer belt to cause the intermediate transfer belt to abut against the image carrying member; and
a current supply unit that has a plurality of contact members contacting an outer peripheral surface of the intermediate transfer belt and supplies current to the intermediate transfer belt, the current supply unit supplying a first total current in a state where the abutting member is pressed against the intermediate transfer belt, so that the toner image is primary-transferred from the image carrying member onto the intermediate transfer belt, wherein
after the toner image is primary-transferred from the image carrying member onto the intermediate transfer belt, in a state where a pressing force by which the abutting member is pressed against the intermediate transfer belt is released to separate the abutting member from the intermediate transfer belt and where a second total current whose value is smaller than a value of the first total current is supplied from the current supply unit, the toner image that is primary-transferred onto the intermediate transfer belt is secondary-transferred onto a transfer material.

15. The image forming apparatus according to claim 14, further comprising:
a facing member that faces the current supply unit with the intermediate transfer belt interposed therebetween; and
a constant voltage element that is electrically connected to the facing member and the abutting member and maintains the facing member and the abutting member at a predetermined voltage by the first total current and the second total current being supplied through the facing member.

16. The image forming apparatus according to claim 15, wherein
a plurality of image carrying members are disposed in a movement direction of the intermediate transfer belt, a plurality of abutting members are disposed at positions corresponding to positions of the plurality of image carrying members with the intermediate transfer belt interposed therebetween, and, after the toner image is primary-transferred from each of the plurality of image carrying members onto the intermediate transfer belt by current flowing from the plurality of abutting members to the plurality of image carrying members, in a state where the pressing force of at least one of the plurality of abutting members is released and where the pressing force of at least one of the plurality of abutting members is not released, the toner image is secondary-transferred from the intermediate transfer belt onto the transfer material.

17. The image forming apparatus according to claim 16, wherein
the current supply unit includes a first contact member that supplies current by which the toner image is secondary-transferred from the intermediate transfer belt onto the transfer material, and a second contact member that is provided on a downstream side of the first contact member in the movement direction of the intermediate transfer belt and subjected to application of voltage from a power supply, and
toner remaining on the intermediate transfer belt after the toner image is secondary-transferred from the intermediate transfer belt onto the transfer material moves with the intermediate transfer belt, is charged while passing through a position where the second contact member, to which voltage of a polarity opposite to a normal charging polarity of toner is applied from the power supply, abuts against the intermediate transfer belt, and then moves from the intermediate transfer belt to the image carrying member at a position where the image carrying member abuts against the intermediate transfer belt.

18. The image forming apparatus according to claim 17, wherein
until the toner remaining on the intermediate transfer belt after the toner image is secondary-transferred from the intermediate transfer belt onto the transfer material finishes moving to the image carrying member, the abutting member the pressing force of which has been released is maintained in a state where the pressing force is released.

19. The image forming apparatus according to claim 16, wherein
I_{A} that is the value of the second total current satisfies:
$${I}_{A} > {I}_{B} \geq ( {I}_{A} - {I}_{Z} ) \frac{{N}_{B}}{{N}_{A}} + {I}_{Z}$$
where a current needed for the constant voltage element to maintain the predetermined voltage is I_{z}, the number of the abutting members pressed against the intermediate transfer belt while the toner image is primary-transferred from the image carrying member onto the intermediate transfer belt is N_{B}, the value of the first total current is I_{B}, and the number of the abutting members the pressing force of which is released after the toner image is primary-transferred from the image carrying member onto the intermediate transfer belt is N_{A}.

20. The image forming apparatus according to claim 16, further comprising:
a detection member that is able to detect current flowing through the constant voltage element; and
a control unit that controls current supplied from the current supply unit in accordance with a value detected by the detection member after the toner image is primary-transferred from the image carrying member onto the intermediate transfer belt.
